(19) United States
(12) Patent Application Publication
(10) Pub. No.: US 2025/0056262 A1
(43) Pub. Date: Feb. 13, 2025

(54) APPARATUS AND METHOD FOR PERFORMING BEAM MANAGEMENT BASED ON RECONFIGURABLE INTELLIGENT SURFACE IN WIRELESS COMMUNICATION SYSTEM

(71) Applicant: ELECTRONICS AND TELECOMMUNICATIONS RESEARCH INSTITUTE, Daejeon (KR)

(72) Inventor: Jae Su SONG, Daejeon (KR)

(21) Appl. No.: 18/799,708

(22) Filed: Aug. 9, 2024

(30) Foreign Application Priority Data
Aug. 11, 2023 (KR) 10-2023-0105638
Jul. 31, 2024 (KR) 10-2024-0101687

(51) Int. Cl. H04W 24/04; H04B 7/04; H04B 7/0408

(52) U.S. Cl. CPC H04W 24/04; H04B 7/04013; H04B 7/0408

(57) ABSTRACT

Proposed are an apparatus and a method for performing beam management based on a reconfigurable intelligent surface (RIS) in a wireless communication system. An operation method of a base station (BS) in a wireless communication system includes performing a beam search using at least one base station beam through a backhaul link between the base station and a reconfigurable intelligent surface (RIS), performing the beam search using a plurality of RIS beams for each of the at least one base station beam on the backhaul link when the RIS is set to a multi-beam mode, setting the RIS to a single-beam mode on an access link when the beam search of the backhaul link is completed, and performing a beam search of the access link by fixing beam information of the backhaul link.

### CROSS REFERENCE TO RELATED APPLICATION

The present application claims priority to Korean Patent Application No. 10-2023-0105638, filed 11 Aug. 2023 and Korean Patent Application No. 10-2024-0101687, filed 31 Jul. 2024, the entire contents of which are incorporated herein for all purposes by this reference.

### BACKGROUND OF THE INVENTION

### Field of the Invention

The present disclosure relates generally to a wireless communication system. More particularly, the present disclosure relates to an apparatus and a method for performing beam management based on a reconfigurable intelligent surface (RIS) in a wireless communication system.

### Description of the Related Art

In a 5G NR system, beamforming technology is essentially applied to solve radio wave attenuation and straightness problems due to the use of a high frequency band. To this end, a three-stage beam management procedure (SSB-based beam sweeping, CSI-RS-based transmission beam refinement, and CSI-RS-based reception beam refinement) is standardised.

In the meantime, to control a wireless channel environment, a reconfigurable intelligent surface (RIS) technology has been introduced, which is a low-cost, high-efficiency solution that uses passive elements to change the phase of incident radio waves to improve a wireless channel. In addition, 3GPP Rel-18 is standardising a network-controlled repeater (NCR), which is a wireless repeater with a beamforming function that operates under the control of a base station to extend network coverage. These technologies will improve the performance of 5G mobile communication systems and enable efficient network establishment.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing an apparatus and a method for performing beam management based on an RIS in a wireless communication system.

In addition, the present disclosure is directed to providing an apparatus and a method for performing RIS-based beam management with low complexity in a wireless communication system.

According to various embodiments of the present disclosure, there is provided an operation method of a base station (BS) in a wireless communication system, the operation method including: performing a beam search using at least one base station beam through a backhaul link between the base station and a reconfigurable intelligent surface (RIS); performing the beam search using a plurality of RIS beams for each of the at least one base station beam on the backhaul link when the RIS is set to a multi-beam mode; setting the RIS to a single-beam mode on an access link when the beam search of the backhaul link is completed; and performing a beam search of the access link by fixing beam information of the backhaul link.

According to various embodiments of the present disclosure, there is provided a base station (BS) in a wireless communication system, the base station including: a transceiver; and a controller operably connected to the transceiver, wherein the controller is configured to perform a beam search using at least one base station beam through a backhaul link between the base station and a reconfigurable intelligent surface (RIS), perform the beam search using a plurality of RIS beams for each of the at least one base station beam on the backhaul link when the RIS is set to a multi-beam mode, set the RIS to a single-beam mode on an access link when the beam search of the backhaul link is completed, and perform a beam search of the access link by fixing beam information of the backhaul link.

According to the apparatus and method according to various embodiments of the present disclosure, low-complexity RIS-based beam management can be performed by performing beam searches with separation of a section between a base station and a reconfigurable intelligent surface (RI and a section between the RIS and a user equipment in a wireless communication system to which the RIS is applied.

Effects that may be obtained from the present disclosure will not be limited to only the above described effects. In addition, other effects which are not described herein will become apparent to those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1A shows a beam management procedure, according to various embodiments of the present disclosure;

FIG. 1B shows an example of an RIS-based single-beam mode, according to various embodiments of the present disclosure;

FIG. 1C shows an example of an RIS-based multi-beam mode, according to various embodiments of the present disclosure;

FIG. 1D shows an example of an NCR structure, according to various embodiments of the present disclosure;

FIG. 2 shows an example of an RIS-based beam search structure, according to an embodiment of the present disclosure;

FIG. 3 shows an example of a beam search structure for a backhaul link, according to an embodiment of the present disclosure;

FIG. 4 shows an example of a beam search structure for an access link, according to an embodiment of the present disclosure;

FIG. 5 shows a flowchart of a beam search procedure to which an RIS is applied, according to an embodiment of the present disclosure;

FIG. 6 shows a configuration diagram of a base station in a wireless communication system according to various embodiments of the present disclosure;

FIG. 7 shows a configuration diagram of a user equipment in a wireless communication system according to various embodiments of the present disclosure; and

FIG. 8 shows a functional configuration of a reconfigurable intelligent surface (RIS) in a wireless communication system, according to various embodiments of the present disclosure.

### DETAILED DESCRIPTION OF THE INVENTION

The terms used in the present disclosure are merely used to describe a particular embodiment, and are not intended to limit the scope of another embodiment. An expression used in the singular encompasses the expression of the plural, unless it has a clearly different meaning in the context. All the terms including technical and scientific terms used herein have the same meaning as commonly understood by those skilled in the art to which the present disclosure belongs. Among the terms used in the present disclosure, the terms defined in a general dictionary may be interpreted to have the meanings the same as or similar to the contextual meanings in the relevant art, and are not to be interpreted to have ideal or excessively formal meanings unless explicitly defined in the present disclosure. In some cases, even the terms defined in the present disclosure should not be interpreted to exclude the embodiments of the present disclosure.

In various embodiments of the present disclosure to be described below, a hardware approach will be described as an example. However, the various embodiments of the present disclosure include a technology using both hardware and software, so the various embodiments of the present disclosure do not exclude a software-based approach.

In addition, in the detailed description and claims of the present disclosure, the expression “at least one of A, B, and C” mean “only A”, “only B”, “only C”, or “any combination of A, B, and C”. In addition, the expression “at least one of A, B, or C” or “at least one of A, B, and/or C” may mean “at least one of A, B, and C”.

Hereinafter, the present disclosure relates to an apparatus and a method for performing beam management based on a reconfigurable intelligent surface (RIS) in a wireless communication system. More particularly, the present disclosure describes a technology for performing low-complexity RIS-based beam management by performing beam searches with separation of a section between a base station and an RIS and a section between the RIS and a user equipment in a wireless communication system to which the RIS is applied.

The terms referring to signals, the terms referring to channels, the terms referring to control information, the terms referring to network entities, the terms referring to elements of an apparatus, and the like used in the description below are only examples for the convenience of description. Accordingly, the present disclosure is not limited to the terms described below, and the terms may be replaced by other terms having the same technical meanings.

In addition, various embodiments of the present disclosure are described using terms used in some communication standards (e.g., the 3rd Generation Partnership Project (3GPP)), but the embodiments are only examples for the description. The various embodiments of the present disclosure may be easily modified and applied to other communication systems.

### [Beam Management]

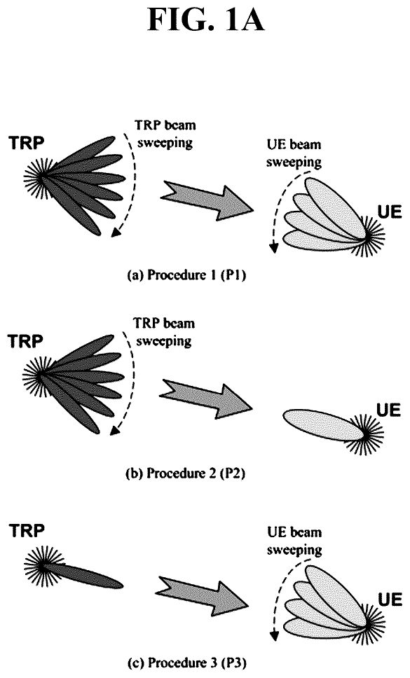

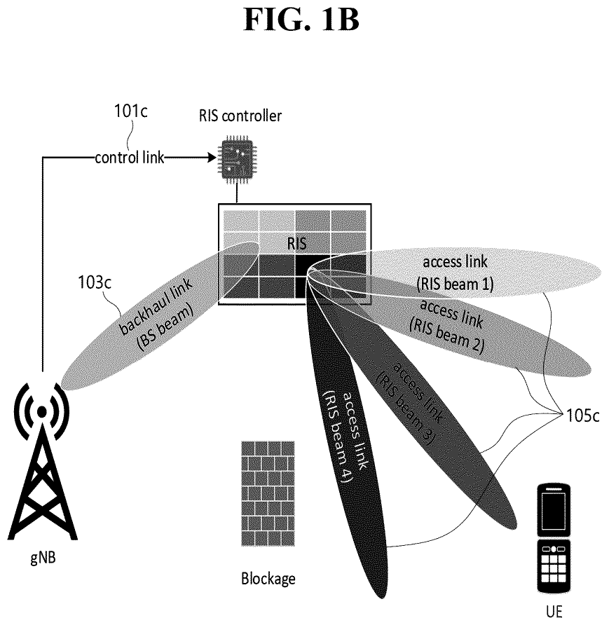

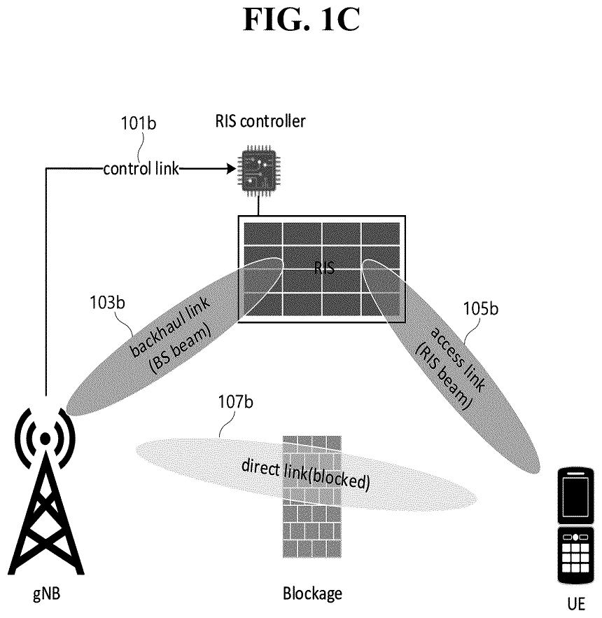

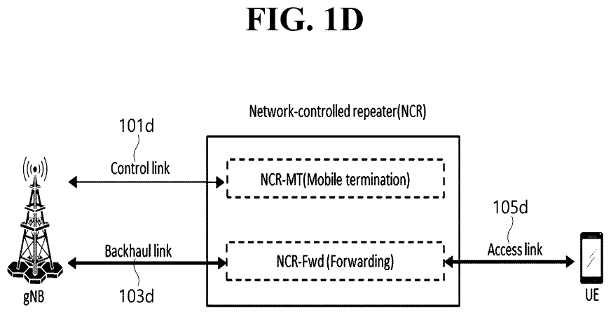

FIG. 1A shows a beam management procedure, according to various embodiments of the present disclosure.

Referring to FIG. 1A, the standard defines several procedures related to beamforming, because NR basically sets a wireless link to which beamforming technology is applied. 3GPP standard document TR 38.802 defines a three-stage bean management procedure as follows.

### (a) Procedure 1 (P1)

SSB-based beam sweeping is to perform SSB-based beam sweeping at a transmitter (base station) and a receiver (user equipment) when the user equipment in an idle state performs initial access. To this end, each transmission beam is periodically transmitted multiple times on the same SSB resource repeatedly, and the user equipment performs beam sweeping for reception beams on the SSB resource. The user equipment measures a received signal received power (RSRP) value for each beam pair measured through Rx beam sweeping, and selects the best beam pair on the basis of the values. The selected beam may be an SSB-based wide beam.

### (b) Procedure 2 (P2)

In CSI-RS-based Tx beam refinement, a narrow (fine) beam for data transmission is selected after the selection of the SSB-based wide beam. To this end, DL uses CSI-RS, and UL uses SRS. CSI-RS-based narrow beams that the base station transmits perform beam sweeping within the SSB-based wide beam range selected in the P1 procedure. However, the user equipment measures the base station CSI-RS beams by setting the SSB-based Rx beam obtained in the P1 procedure to be the same. Accordingly, this procedure may be called a beam adjustment procedure for an CSI-RS-based transmission beam of a base station.

### (c) Procedure 3 (P3)

CSI-RS based Rx beam refinement is a beam refinement procedure for a reception beam of a user equipment. The base station transmits the CSI-RS-based beam selected in P2 repeatedly, and the user equipment selects the optimal Rx beam by performing beam sweeping through the CSI-RS beam defined within the SSB-based Rx beam range selected in P1.

FIG. 1B shows an example of an RIS-based single-beam mode, according to various embodiments of the present disclosure.

FIG. 1C shows an example of an RIS-based multi-beam mode, according to various embodiments of the present disclosure.

The evolution of wireless communication systems requires wide frequency bands to support application services that require high data transfer rates. However, in order to secure broadband system bandwidths, increasingly higher frequencies, such as mmWave or THz, need to be used. However, as is well known, higher frequencies are associated with greater radio wave attenuation and more radio wave straightness, making it difficult to secure coverage. To overcome this, schemes for applying beamforming technology and installing multiple base stations or relays are considered. However, these methods lead to increased costs for service providers, thus have limitations. For this reason, a scheme for applying a low-cost device called a reconfigurable intelligent surface (RIS) to a wireless communication system has recently been discussed. In conventional mobile communication technology, a wireless channel environment is an uncontrollable area, so it is designed to compensate for the impairment of a wireless channel at only two end points (the transmitter and the receiver) of a communication link.

Referring FIG. 1B, unlike these conventional approaches, the RIS takes the approach of controlling a wireless channel environment itself as part of a wireless communication system. The RIS may be realized in various ways. Conceptually, the RIS is a surface composed of several passive elements, and each of the elements may independently change the phase of an incident electromagnetic wave. That is, this is the concept that performs control in such a manner that a wireless channel itself is changed by reflecting an incident radio wave in a particular direction or transmitting an incident radio wave to improve communication performance. This may be interpreted as a conventional wireless communication system having a degree of freedom to control a wireless channel. In addition, since the RIS use passive elements rather than active elements requiring power, the RIS may be installed at a low cost and may consume less power compared to equipment such as conventional relays. In order to control the RIS, a device for receiving control information from a wireless communication node (usually a base station) and setting the RIS is required, which is called an RIS-controller. In this document, this device is referred to as an RIS-controller or an RIS-C.

FIG. 1B shows the structure of a mobile communication system to which an RIS is applied. Between a base station and a RIS controller, a control link 101b, 101c for the base station to control an RIS is defined. Wireless links between the base station and a user equipment are separated into a section between a base station and an RIS and a section between the RIS and a user equipment. The former is referred to as a backhaul link 103b, 103c, and the latter is referred to as an access link 105b, 105c. The base station controls each of the passive elements installed at the RIS to change the phase of a radio wave incident on the RIS, thereby controlling the direction in which the radio wave reflects. Therefore, from the perspective of beamforming, it may be interpreted that the introduction of the RIS adds a domain for beam management. That is, in the related art, for beamforming, a beam management procedure is performed only at end points (a user equipment and a base station) of a beam, such as a direct link 107b. However, with the introduction of the RIS, beam management for the backhaul link and beam management for the access link are required together.

The two beams described above do not exist independently, but affect each other. Thus, beam management needs to be performed simultaneously. That is, when beam failure detection (BFD) occurs at the user equipment, it is impossible to know whether BFD occurs on the backhaul link or the access link. Therefore, in order to find a new beam, beam searches need to be performed for both the backhaul link and the access link. This case requires beam searches of which the number is equal to a value obtained by multiplying the numbers of beams defined in the respective links. A beam search scheme for reducing the complexity of beam searches is required.

In the meantime, the RIS may control the passive elements constituting the RIS so that one beam is generated or several beams are generated simultaneously. In order to generate several beams simultaneously, one example of configuring the RIS is to split the passive elements into several subarrays and perform control such that the passive elements belonging to each subarray have the same phase shift. This configuration allows the RIS to generate independent beams for respective subarrays simultaneously. In the present disclosure, the RIS setting for generating one beam is referred to as a single-beam mode, and the RIS setting for generating several beams simultaneously is referred to as a multi-beam mode. FIG. 1B shows, as the single-beam mode, an example of the RIS setting for generating one beam. FIG. 1C shows, as the multi-beam mode, an example of the RIS setting for generating four beams simultaneously.

FIG. 1D shows an example of an NCR structure, according to various embodiments of the present disclosure.

The network-controlled repeater (NCR) is a network node that is being standardised in Rel-18 of 3GPP. The NCR is a wireless repeater that fundamentally operates in an amplify-and-forward (AF) method of amplifying and transmitting analog signals without decoding received signals, and additionally has a beamforming function.

As defined in the current standard, the NCR operates under the control of the base station, is installed by a service provider, is not mobile, and operates in a single-hop method. The NCR is an in-band repeater that is used for extending network coverage and uses the same frequency band on a control link, an interface for control, and on a link for data transmission.

Referring to FIG. 1D, the NCR is internally composed of an NCR mobile terminal (NCR-MT) and an NCR forwarding (NCR-Fwd). The NCR-MT may communicate with the base station (gNB) through the control link 101d and may perform a function of transmitting and receiving control information (side control information (SCI)). The control link 101d is defined on the basis of an NR Uu interface, and the NCR-MT is basically considered to be a UE and performs required functions of the UE. On the other hand, the NCR-Fwd performs a function of amplifying and transmitting RF signals between the user equipment UE) and the base station (gNB). Herein, a section between the gNB and the NCR is defined as a backhaul link 103d, and a section between the NCR and the UE is defined as an access link 105d. The operation of the NCR-Fwd is performed according to SCI information received from the base station through the control link 101d.

In general, the NCR-MT and the NCR-Fwd may use the same frequency or different frequencies. 3GPP Rel-18 standard stipulates the use of the same frequency. It may be much easier to manage the backhaul link 103d when the same frequency is used. The NCR performs a beamforming function by multiple antennas. That is, beamforming is applied to the backhaul link 103d and the access link 105d. When the NCR-MT and the NCR-Fwd use the same frequency, it may be expected that the wireless channels of the control link 101d and the backhaul link 103d show the same large-scale characteristics. In this case, a transmission configuration indicator (TCI) on the control link 101d may be applied in the same manner to the backhaul link 103d. That is, this means that a beam obtained through a beam search on the control link 101d may be used in the same manner on the backhaul link 103d. 3GPP standard also defines that the control link 101d and the backhaul link 103d use the same beam.

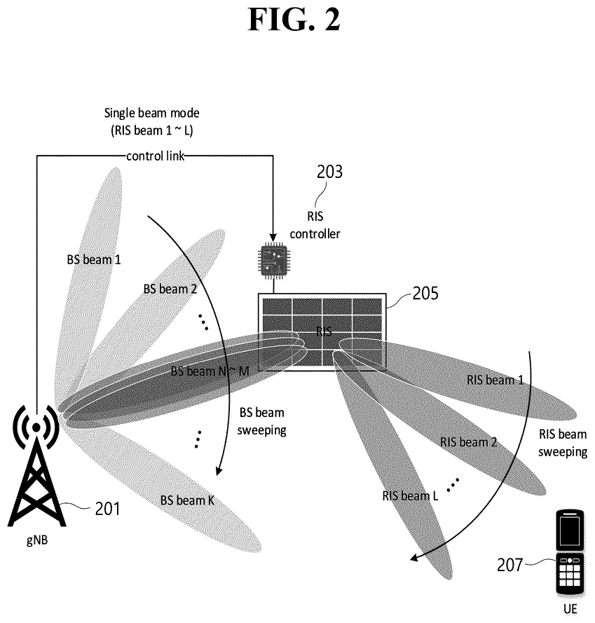

FIG. 2 shows an example of an RIS-based beam search structure, according to an embodiment of the present disclosure.

Referring to FIG. 2, the RIS is similar in function and structure to the NCR, which is being standardised by 3GPP. The NCR is a type of repeater that amplifies RF signals in an amplify-and-forward method, and may perform a beamforming function under the control of the base station rather than simply performing only signal amplification.

To this end, the structure shown in FIG. 1D is defined. The NCR may be composed of the NCR-Fwd for performing RF signal amplification of the data channel, and the NCR-MT for controlling the operation of the NCR under the control of the base station. A section between the base station and the NCR-Fwd may be defined as a backhaul link 103d, and a link between the NCR-Fwd and the user equipment may be defined as an access link 105d. In addition, an interface between the base station and the NCR-MT for control of the NCR may be called the control link 101d and may be defined on the basis of the NR Uu interface.

Since the in-band method in which the same frequency is used is applied to the control link 101d and the backhaul link 103d, the control link 101d and the backhaul link 103d may share beam information. That is, a beam obtained through a beam search on the control link 101d may also be applied to the backhaul link 103d.

Referring to FIG. 2, the RIS is not yet dealt with in 3GPP standard, so its structure or interface is not defined. However, it is reasonable to define the RIS as having a similar structure to the NCR due to functional similarities. First, an RIS-controller 203 for controlling the RIS by receiving a control signal from a base station 201 or a network node defined for controlling the RIS is required, and the RIS-controller corresponds to the NCR-MT of the NCR. Therefore, it is assumed that the control interface between the RIS-controller 203 and the base station 201 is also defined on the basis of the NR Uu interface as in the NCR.

In addition, the wireless links between the base station 201 and the RIS 205, and between the RIS 205 and a user equipment 207 may be defined as a backhaul link and an access link as in the NCR. The difference between the NCR and the RIS is that the NCR uses active elements to amplify RF signals, but the RIS 205 uses passive elements and therefore does not amplify RF signals.

The beam search structure in the RIS-based mobile communication system is as shown in FIG. 2. A base station transmission beam in the backhaul link section is referred to as a BS beam, and a transmission beam from the RIS in the access link section is referred to as an RIS beam. The base station 201 performs beam sweeping for the base station coverage with K BS beams, and the RIS 205 performs beam sweeping for the RIS coverage with L RIS beams. In order to enable the user equipment 207 to perform a beam search for connection establishment while the base station 201 does not know the locations (directions) of the RIS 205 and the user equipment 207, the base station 201 needs to perform RIS beam sweeping for each BS beam. That is, while a BS beam is fixed, beam sweeping is performed for the RIS beam, and this is repeated for all BS beams. In this process, all combinations of BS beams and RIS beams need to be considered. As a result, beam sweeping needs to be performed with beams resulting from multiplying the number of BS beams and the number of RIS beams. FIG. 2 shows such beam sweeping and complexity is K×L.

In such an RIS-based beam search structure, simultaneously performing beam searches via the backhaul link (BS beam) and the access link (RIS beam) has high complexity. In order to reduce the complexity, the present disclosure provides a scheme for performing beam searches in two stages with separation of the backhaul link and the access link.

According to the present disclosure, a beam search of the backhaul link is performed to find a BS beam first in Stage 1, and a beam search of the access link is performed in Stage 2. In Stage 2, the interdependence between the backhaul link and the access link is eliminated by fixing the backhaul link with the BS beam obtained in Stage 1 and performing a beam search only for the access link.

In addition, the present disclosure proposes a scheme for low complexity according to inband and outband situations depending on the frequency band relationship between the control link and the backhaul link. In the inband and outband cases, the beam search procedures in Stage 1 are different and the beam search procedure in Stage 2 is the same.

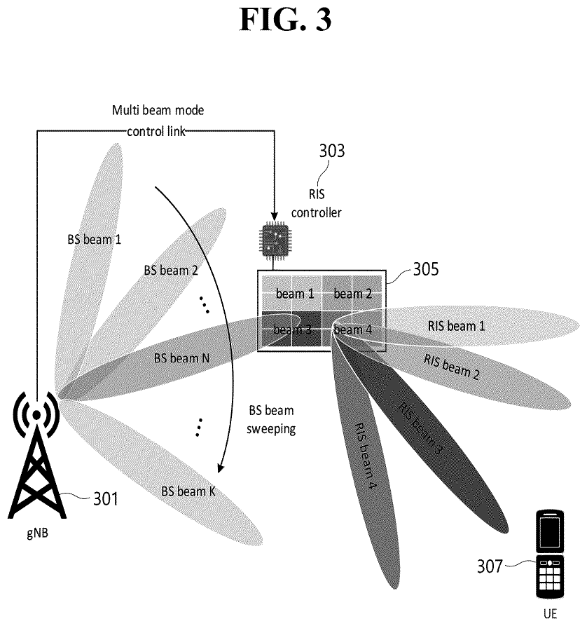

FIG. 3 shows an example of a beam search structure for a backhaul link, according to an embodiment of the present disclosure.

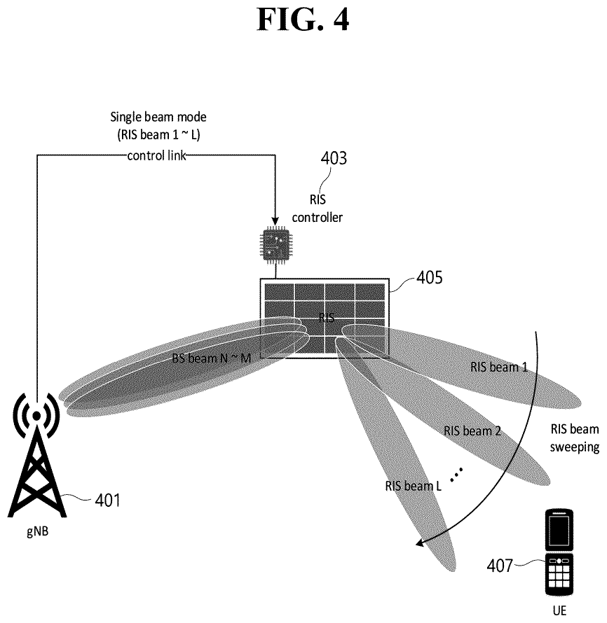

FIG. 4 shows an example of a beam search structure for an access link, according to an embodiment of the present disclosure.

Referring to FIGS. 3 and 4, the present disclosure proposes a scheme for low complexity according to inband and outband situations depending on the frequency band relationship between the control link and the backhaul link. In the inband and outband cases, the beam search procedures in Stage 1 may be different and the beam search procedure in Stage 2 may be the same.

### [Inband Case]

Stage 1: Stage 1 may mean the case in which the control link and the backhaul link use the same frequency band (or the frequency band of the control link is included in the frequency band of the backhaul link). This case may mean that the control link and the backhaul link have the same channel characteristics, so may use the same beam. In order for an RIS 305, 405 to generate a control link with a base station 301, 401, wireless access needs to be performed by an RIS-controller 303, 403 according to the procedure defined in NR Uu. In this process, a beam search may be performed between the base station 301, 401 and the RIS-controller 303, 403 according to the procedure proposed with reference to FIG. 3, and a beam to be used on the control link may be obtained. Since the RIS-controller 303, 403 and the RIS 305, 405 are at the same location, beam information (spatial filter) of the control link obtained in this way may be used in the same manner on the backhaul link in the inband case. That is, there is no need to perform beam sweeping for the backhaul link separately.

Stage 2: after obtaining the beam information (spatial filter) from the control link, Stage 2 may perform beam sweeping for the access link (RIS beam) by fixing the beam of the backhaul link with the spatial filter of the control link and changing a beam ID as shown in FIG. 4. Beam sweeping for the access link may be performed through RIS control, which may be done by setting the RIS to the single-beam mode. The BS beam IDs on the backhaul link may correspond to the RIS beams of the access link in a one-to-one manner. The beam sweeping complexity according to this procedure may be calculated as the value obtained by adding the number of BS beams and the number of RIS beams. In the base station and RIS structure shown in FIG. 2, complexity may be calculated as K+L.

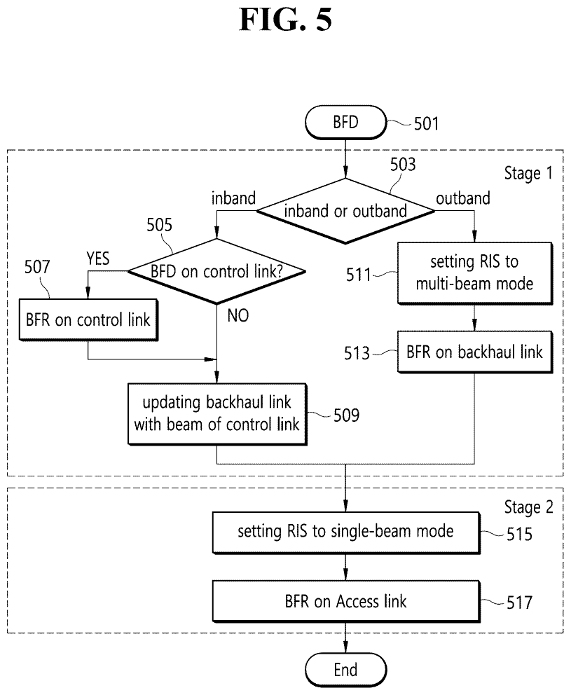

According to an embodiment, when beam failure detection (BFD) occurs at the user equipment 307, 407, but BFD does not occur at the RIS-controller 303, 403, the BFD occurring at the user equipment 307, 407 may mean that BFD occurs on the access link. Therefore, in this case, an existing beam is still used on the backhaul link, and a beam search is performed only for the access link. In this case, according to FIG. 5, beam search complexity may be L, the number of RIS beams.

### [Outband Case]

Stage 1: when the control link and the backhaul link use different frequency bands, there is no guarantee that the beam used on the control link is used in the same manner on the backhaul link. Therefore, the beam search procedure for the control link and the beam search procedure for the backhaul link/access link need to be performed independently. Since the RIS-controller performs the functions of a general user equipment, the beam search procedure for the control link may be performed through a general beam search procedure between the user equipment 307, 407 and the base station 301, 401 as shown in FIG. 2. Therefore, beam search complexity may correspond to the number of BS beams. In beam searches for the backhaul link and the access link, there is no beam measurement function in the RIS, so the base station 301, 401 and the user equipment 307, 407 serve as end points and the beam search procedure needs to be performed. In this case, as described above, considering the backhaul link and the access link simultaneously, beam searches need to be performed through beam sweeping for all combinations of BS beams and RIS beams, resulting in excessively high complexity. To reduce complexity, according to the present disclosure, the backhaul link and the access link are separated, and a beam search for the backhaul link may be performed first, and after the backhaul link beam search is completed, a beam search for the access link may be performed.

First, for a beam search for the backhaul link, the RIS may use the multi-beam mode described with reference to FIG. 3. That is, when beam sweeping for the BS beam is performed while the RIS is set to the multi-beam mode, measurement for the BS beam may be performed regardless of the location of the user equipment within the RIS. This is because the RIS itself does not have the capability to perform beam measurement. The multi-beam mode of the RIS is, as described above, to split the multiple passive elements constituting the RIS into L subarrays and applying the same setting to all passive elements in the subarray, thereby generating one RIS beam for each subarray. That is, as many RIS beams may be simultaneously generated as there are subarrays.

According to an embodiment, when as many subarrays are set as there are RIS beams, the RIS beams for simultaneously sweeping the entire area of the RIS may be generated simultaneously.

FIG. 3 shows an embodiment of a situation in which the RIS 305, 405 is split into four subarrays and an RIS beam is generated for each subarray. When BS beam N is set on the backhaul link, four RIS beams are generated on the access link and the user equipment may receive one of the RIS beams. Accordingly, a beam search (BS beam N) on the backhaul link may be completed through beam measurement at the user equipment.

Stage 2: when a beam search for the backhaul link is completed according to the above-described procedure, a beam search for the access link is performed. A beam search for the access link may be performed by fixing the beam direction of the backhaul link (the same spatial filter is used) as shown in FIG. 4 and varying a beam ID and setting the single-beam mode through RIS control, thereby performing beam sweeping. Again, beam measurement is performed at the user equipment 307, 407, and best beam selection may be performed on the basis of a beam measurement value. In FIG. 4, several beams (BS beams N to M) to which the same spatial filter is applied are set for the backhaul link with varying a beam ID, and simultaneously, the RIS is in the single-beam mode and RIS beam 1 to RIS beam L are set. That is, BS beam N is mapped to RIS beam 1, and BS beam N+1 is mapped to RIS beam 2. During this beam sweeping process, an RIS beam is selected through a beam measurement value measured at the user equipment 307, 407. The beam search complexity in the outband case described above may be considered as a value obtained by adding a beam search for the backhaul link and a beam search for the access link. Considering this point, complexity may be K+L in FIGS. 3 and 4. This procedure may be performed in the same manner for inband and outband.

According to the beam management procedure in the RIS-based wireless communication system, the base station needs to know the number of RIS beams when setting the RIS. The number of RIS beams is denoted by L in FIGS. 2 and 4, and may be information on how many RIS beams the entire RIS area is composed of. L may also denote the number of subarrays into which the RIS is split, and may be equal to the number of beams simultaneously generated when the RIS is set to the multi-beam mode.

According to an embodiment, L may be information used by the base station to set the RIS when a beam search for the access link is performed after a beam search of the backhaul link is completed, as shown in FIG. 4. Therefore, the RIS needs to transmit L to the base station when performing initial access.

FIG. 5 shows a flowchart of a beam search procedure to which an RIS is applied, according to an embodiment of the present disclosure.

FIG. 5 shows a flowchart of the RIS-based beam search procedure described above. Herein, beam failure detection (BFD) may mean that an event in which a user equipment measures a beam measurement value at or less than a threshold value and requires a new beam to be found has occurred. Beam failure recovery (BFR) may mean a series of procedures for searching for and measuring a new beam to update beam information since BFD has occurred. The details of the beam search procedure are as follows.

A user equipment may detect whether BFD has occurred through beam measurement at the user equipment in step 501.

A base station may determine whether the control link between the base station and the RIS-controller is inband or outband in step 503. That is, it may be determined whether the frequency band used by the control link is included in the frequency band of the backhaul link.

When the RIS is inband, the base station may determine whether BFD has occurred on the control link, in step 505. When BFD occurs, the base station and the RIS-controller may perform a BFR procedure between the base station and the RIS-controller in step 507. Specifically, the base station may update the beam information (spatial filter) of the backhaul link with the beam of the control link in step 509.

When the RIS is outband, the base station may set the RIS to the multi-beam mode in step 511. Specifically, the step 511 may include the step of performing a beam search for the backhaul link by the base station and performing beam measurement by the user equipment. When BFD occurs, the user equipment and the RIS may perform a BFR procedure between the user equipment and the RIS-controller in step 513. Specifically, the step 513 may include the step of updating beam information of the backhaul link on the basis of a beam measurement value obtained by the user equipment.

The base station may set the RIS to the single-beam mode in step 515.

The base station and the user equipment may perform BFR for the access link in step 517.

According to an embodiment, the step 517 may include: setting, by the base station, the beam of the backhaul link by using beam information (spatial filter) obtained through BFR for the backhaul link; performing a beam search for the access link (RIS beam) by the base station and performing beam measurement by the user equipment; and updating, by the base station, beam information of the access link on the basis of a beam measurement value obtained by the user equipment.

The present disclosure aims to address the problem with increased complexity due to performing beam searches for beamforming function in a wireless communication system to which an RIS is applied. By applying the RIS to the wireless communication system, a scheme for reconfiguring a wireless channel is provided, but this results in an increase in complexity due to beam searches from the perspective of beamforming. The present disclosure proposes a scheme for reducing this complexity, and the solutions according to the scheme are as follows.

The present disclosure may include a beam management scheme that separates a beam search of the section (backhaul link) between the base station and the RIS from a beam search of the section (access link) between the RIS and the user equipment and is performed in two stages in a wireless communication system to which the RIS is applied.

(Stage 1) According to an embodiment, the present disclosure may include a beam management scheme in which when the frequency band used on the control link of the RIS is the same as the frequency band of the backhaul link or is included in the frequency band of the backhaul link, the beam used on the control link is used in the same manner on the backhaul link.

(Stage 1) According to an embodiment, the present disclosure may include a beam management scheme in which when the frequency band used on the control link of the RIS is not the same as the frequency band of the backhaul link or is not included in the backhaul link, a beam search between the base station and the user equipment is performed for a beam search of the backhaul link, but the RIS is set to the multi-beam mode and a beam search of the backhaul link is performed.

According to an embodiment, the present disclosure may include a beam management scheme in which when BFD occurs at a user equipment, but BFD does not occur at the RIS-controller, BFR is not performed and an existing beam is still used on the backhaul link.

According to an embodiment, the present disclosure may include a beam management scheme in which when BFD occurs at the user equipment and BFD occurs at the RIS-controller, BFR is performed on the control link and beam information (spatial filter) of the control link is applied to the backhaul link.

(Stage 2) According to an embodiment, the present disclosure may include a beam management scheme in which when a beam search for the access link is performed, the beam of the backhaul link is fixed and the RIS is set to the single-beam mode.

(Stage 2) According to an embodiment, the present disclosure may include an access link beam search scheme in which when a beam search for the access link is performed, the beam of the backhaul link may use the spatial filter selected in Stage 1 and as many beam searches are performed as there are RIS beams by varying a beam ID.

According to an embodiment, the present disclosure may include, as RIS information to be provided to the base station when the RIS is registered in the base station (initial access), RIS information that includes information on the number of RIS beams required to perform sweeping on the entire RIS area.

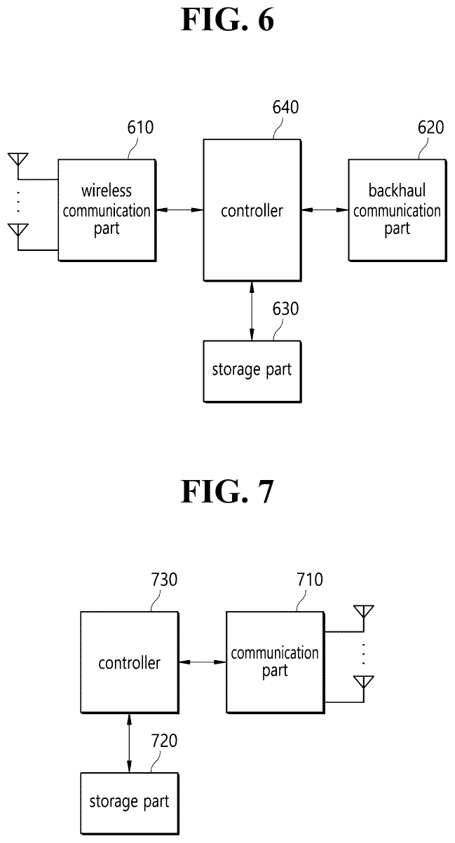

FIG. 6 shows a configuration diagram of a base station in a wireless communication system according to various embodiments of the present disclosure. The configuration illustrated in FIG. 6 may be understood as a configuration of a base station. The terms “˜part”, “˜unit”, and the like used below mean a unit for processing at least one function or operation, and may be implemented by hardware, software, or a combination of hardware and software.

Referring to FIG. 6, a base station may include a wireless communication part 610, a backhaul communication part 620, a storage part 630, and a controller 640.

The wireless communication part 610 may transmit and receive wireless signals through a wireless channel. For example, the wireless communication part 610 may perform a function of conversion between a baseband signal and a bit string according to the physical layer standards of a system. In addition, when transmitting data, the wireless communication part 610 may generate complex symbols by encoding and modulating a transmission bit string. When receiving data, the wireless communication part 610 may restore a reception bit string by demodulating and decoding a baseband signal.

In addition, the wireless communication part 610 may up-convert a baseband signal into a radio frequency (RF) band signal and transmit the RF band signal through an antenna, and may down-convert an RF band signal received through an antenna into a baseband signal. To this end, the wireless communication part 610 may include a transmission filter, a reception filter, an amplifier, a mixer, an oscillator, a digital-to-analog converter (DAC), and an analog-to-digital converter (ADC).

The wireless communication part 610 may include multiple transmission and reception paths. The wireless communication part 610 may include at least one antenna array composed of multiple antenna elements.

In terms of hardware, the wireless communication part 610 may include a digital unit and an analog unit. The analog unit may include multiple sub-units according to operating power or operating frequency. The digital unit may be realized as at least one processor (e.g., digital signal processor (DSP)).

The wireless communication part 610 may transmit and receive wireless signals as described above. Accordingly, all or part of the wireless communication part 610 may be referred to as a “transmitter”, “receiver”, or “transceiver”. In addition, in the following description, transmission and reception performed through a wireless channel may include the above-described processing performed by the wireless communication part 610.

The backhaul communication part 620 may provide an interface for performing communication with other nodes in the network. That is, the backhaul communication part 620 may convert bit strings transmitted from the base station to other nodes, such as other access nodes, other base stations, a parent node, and a core network, into physical signals, and may convert physical signals received from other nodes into bit strings.

The storage part 630 may store therein data, such as default programs, application programs, and setting information for the operation of the base station. The storage part 630 may be a volatile memory, a non-volatile memory, or a combination of a volatile memory and a non-volatile memory. In addition, the storage part 630 may provide stored data according to a request of the controller 640.

The controller 640 may control overall operations of the base station. For example, the controller 640 may transmit and receive signals through the wireless communication part 610 or the backhaul communication part 620. In addition, the controller 640 may record data on the storage part 630 and may read the data. In addition, the controller 640 may perform functions of a protocol stack that communication standards require.

To this end, the controller 640 may include at least one processor.

According to various embodiments of the present disclosure, the controller 640 may perform control so that the base station performs the operations according to various embodiments described with reference to FIGS. 1 to 5.

FIG. 7 shows a configuration diagram of a user equipment in a wireless communication system according to various embodiments of the present disclosure. The configuration illustrated in FIG. 7 may be understood as a configuration of a user equipment. The terms “˜part”, “˜unit”, and the like used below mean a unit for processing at least one function or operation, and may be implemented by hardware, software, or a combination of hardware and software.

Referring to FIG. 7, a user equipment may include a communication part 710, a storage part 720, and a controller 730.

The communication part 710 may perform functions for transmitting and receiving signals through a wireless channel. For example, the communication part 710 may perform a function of conversion between a baseband signal and a bit string according to the physical layer standards of a system. For example, when transmitting data, the communication part 710 may generate complex symbols by encoding and modulating a transmission bit string. When receiving data, the communication part 710 may restore a reception bit string by demodulating and decoding a baseband signal. In addition, the communication part 710 may up-convert a baseband signal into an RF band signal and transmit the RF band signal through an antenna, and may down-convert an RF band signal received through an antenna into a baseband signal. For example, the communication part 710 may include a transmission filter, a reception filter, an amplifier, a mixer, an oscillator, a DAC, and an ADC.

In addition, the communication part 710 may include multiple transmission and reception paths. Furthermore, the communication part 710 may include at least one antenna array composed of multiple antenna elements. In terms of hardware, the communication part 710 may be a digital circuit and an analog circuit (for example, a radio frequency integrated circuit (RFIC)). Herein, the digital circuit and the analog circuit may be realized as one package. In addition, the communication part 710 may include multiple RF chains. Furthermore, the communication part 710 may perform beamforming.

The communication part 710 transmits and receives signals as described above. Accordingly, all or part of the communication part 710 may be referred to as a “transmitter”, “receiver”, or “transceiver”. In addition, in the following description, transmission and reception performed through a wireless channel may be used to mean that the communication part 710 performs the above-described processing.

The storage part 720 may store therein data, such as default programs, application programs, and setting information for the operation of the user equipment. The storage part 720 may be a volatile memory, a non-volatile memory, or a combination of a volatile memory and a non-volatile memory. In addition, the storage part 720 may provide stored data according to a request of the controller 730.

The controller 730 may control overall operations of the user equipment. For example, the controller 730 may transmit and receive signals through the communication part 710. In addition, the controller 730 may record data on the storage part 720 and may read the data. The controller 730 may perform functions of a protocol stack that communication standards require. To this end, the controller 730 may include at least one processor or microprocessor, or may be part of a processor. In addition, part of the communication part 710 and the controller 730 may be referred to as a communication processor (CP).

According to various embodiments, the controller 330 may perform control so that the user equipment performs the operations according to the various embodiment described with reference to FIGS. 1 to 5.

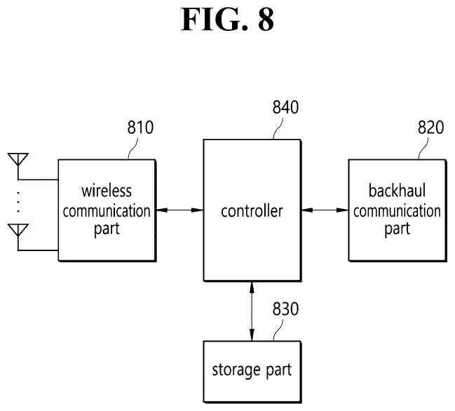

FIG. 8 shows a functional configuration of a reconfigurable intelligent surface (RIS) in a wireless communication system, according to various embodiments of the present disclosure. According to an embodiment, FIG. 8 may be understood as a functional configuration of an RIS controller that an RIS includes. The configuration illustrated in FIG. 4 may be understood as a configuration of an RIS. The terms “˜part”, “˜unit”, and the like used below mean a unit for processing at least one function or operation, and may be implemented by hardware, software, or a combination of hardware and software.

Referring to FIG. 8, an RIS may include a wireless communication part 810, a backhaul communication part 820, a storage part 830, and a controller 840. The wireless communication part 810 performs functions for transmitting and receiving signals through a wireless channel. For example, the wireless communication part 810 performs a function of conversion between a baseband signal and a bit string according to the physical layer standards of a system. For example, when transmitting data, the wireless communication part 810 generates complex symbols by encoding and modulating a transmission bit string. In addition, when receiving data, the wireless communication part 810 restores a reception bit string by demodulating and decoding a baseband signal. In addition, the wireless communication part 810 up-converts a baseband signal into a radio frequency (RF) band signal and transmits the RF band signal through an antenna, and down-converts an RF band signal received through an antenna into a baseband signal. The wireless communication part 810 of the RIS may receive a signal from a base station, and may reflect the received signals to transmit the same to a user equipment. In addition, the wireless communication part 810 of the RIS may receive a signal from a user equipment, and may reflect the received signal to transmit the same to a base station. Herein, the RIS may reflect the received signal as it is, or may transmit a signal generated on the basis of information on the received signal through the wireless communication part 810. According to an embodiment, the RIS may adjust an RIS reflection pattern on the basis of a control signal received from a base station, and may reflect the received signal on the basis of the adjusted RIS reflection pattern.

To this end, the wireless communication part 810 may include a transmission filter, a reception filter, an amplifier, a mixer, an oscillator, a digital-to-analog converter (DAC), and an analog-to-digital converter (ADC). In addition, the wireless communication part 810 may include multiple transmission and reception paths. Furthermore, the wireless communication part 810 may include at least one antenna array composed of multiple antenna elements. In terms of hardware, the wireless communication part 810 may include a digital unit and an analog unit. The analog unit may include multiple sub-units according to operating power or operating frequency.

In addition, the wireless communication part 810 may include a plurality of reflection elements (REs). On the basis of the plurality of REs, the wireless communication part 810 may reflect a signal. When reflecting the signal, the amplitude and phase of the received signal may be adjusted by a particular value. The combination of the amplitude and phase of the signal to be adjusted by the particular value may be referred to as a reflection pattern. According to an embodiment, signal reflection based on various reflection patterns may include a function substantially the same as or similar to beamforming of a base station.

The wireless communication part 810 may transmit and receive signals. To this end, the wireless communication part 810 may include at least one transceiver. For example, the wireless communication part 810 may transmit a synchronization signal, a reference signal, system information, a message, control information, or data. In addition, the wireless communication part 810 may perform beamforming.

The wireless communication part 810 transmits and receives signals as described above. Accordingly, all or part of the wireless communication part 810 may be referred to as a “transmitter”, “receiver”, or “transceiver”. In addition, in the following description, transmission and reception performed through a wireless channel may be used to mean that the wireless communication part 810 performs the above-described processing.

The backhaul communication part 820 may provide an interface for performing communication with other nodes in the network. That is, the backhaul communication part 820 may convert bit strings transmitted from the RIS to other nodes, such as other access nodes, base stations, a parent node, and a core network, into physical signals, and may convert physical signals received from other nodes into bit strings. According to an embodiment, the RIS may receive setting information for a reflection pattern and a reflection pattern period from a base station through the backhaul communication part 820.

The storage part 830 may store therein data, such as default programs, application programs, and setting information for the operation of the RIS. The storage part 830 may include a memory. The storage part 830 may be a volatile memory, a non-volatile memory, or a combination of a volatile memory and a non-volatile memory. In addition, the storage part 830 may provide stored data according to a request of the controller 840. According to an embodiment, the storage part 830 may pre-store information (that is, RIS beambook) on a plurality of reflection patterns applied to the RIS.

The controller 840 controls overall operations of the RIS. For example, the controller 840 may transmit and receive signals through the wireless communication part 810 or the backhaul communication part 820. In addition, the controller 840 may record data on the storage part 830, and may read the data. In addition, the controller 840 may perform functions of a protocol stack that communication standards require. To this end, the controller 840 may include at least one processor.

The configuration of the RIS shown in FIG. 8 is merely an example of the RIS, and examples of base stations performing various embodiments of the present disclosure are not limited to the configuration shown in FIG. 8. That is, according to various embodiments, some configurations may be added, deleted, or changed.

Methods according to the embodiments described in the claims of the present disclosure or in the specification may be implemented in the form of hardware, software, or a combination of hardware and software.

In the case of software implementation, a computer-readable storage medium in which at least one program (software module) is stored may be provided. The at least one program stored in the computer-readable storage medium is configured to be executable by at least one processor in an electronic device. The at least one program includes instructions for the electronic device to execute the methods according to the embodiments described in the claims of the present disclosure or the specification.

The program (software module or software) may be stored in non-volatile memory including random-access memory and flash memory, read-only memory (ROM), electrically erasable programmable read-only memory (EEPROM), a magnetic disc storage device, a compact disc-ROM (CD-ROM), digital versatile discs (DVDs), optical storage devices of other types, or a magnetic cassette. Alternatively, the program may be stored in a memory composed of a combination of some or all of these memories. In addition, a plurality of such memories may be included.

In addition, the program may be stored in an attachable storage device that is accessible through a communication network, such as the Internet, Intranet, a local area network (LAN), a wide area network (WAN), or a storage area network (SAN), or a combination thereof. The storage device may be connected through an external port to an apparatus performing an embodiment of the present disclosure. In addition, a separate storage device on the communication network may be connected to the apparatus performing an embodiment of the present disclosure.

In the above-described detailed embodiments of the disclosure, an element included in the disclosure is expressed in the singular or the plural according to a presented detailed embodiment. However, the singular form or plural form is selected suitable for the presented situation for convenience of description, and the various embodiments of the disclosure are not limited to a single element or multiple elements thereof. Further, either multiple elements expressed in the description may be configured into a single element or a single element in the description may be configured into multiple elements.

Although the specific embodiments have been described in the detailed description of the present disclosure, various modifications and changes may be made thereto without departing from the scope of the present disclosure. Therefore, the scope of the present disclosure should not be defined as being limited to the embodiments, but should be defined by the appended claims and equivalents thereof.

What is claimed is:

1. A method performed by a base station (BS) in a wireless communication system, the method comprising:
performing a beam search using at least one base station beam through a backhaul link between the base station and a reconfigurable intelligent surface (RIS);
performing the beam search using a plurality of RIS beams for each of the at least one base station beam on the backhaul link when the RIS is set to a multi-beam mode;
setting the RIS to a single-beam mode on an access link when the beam search of the backhaul link is completed; and
performing a beam search of the access link by fixing beam information of the backhaul link.

2. The method of claim 1, wherein when a frequency band used on a control link of the RIS is the same as a frequency band of the backhaul link or is included in the frequency band of the backhaul link, a beam used on the control link is used in the same manner on the backhaul link.

3. The method of claim 1, wherein when a frequency band used on a control link of the RIS is different from a frequency band of the backhaul link or is not included in the backhaul link, the beam search of the backhaul link is performed in cooperation with a user equipment (UE).

4. The method of claim 2, wherein when beam failure detection (BFD) occurs at a user equipment, but BFD does not occur at an RIS controller included in the RIS, an existing beam is still used on the backhaul link and beam failure recovery (BFR) is not performed.

5. The method of claim 2, wherein when beam failure detection (BFD) occurs at a user equipment and BFD occurs at an RIS controller included in the RIS, beam failure recovery (BFR) is performed for the control link, and
beam information of the control link is applied to the backhaul link.

6. The method of claim 1, wherein when the base station performs the beam search for the access link, a beam of the backhaul link is fixed and the RIS is set to the single-beam mode.

7. The method of claim 6, wherein when the beam search for the access link is performed, the plurality of RIS beams are set on the basis of the beam information of the backhaul link, and
the beam search of the access link is performed while changing an ID of each of the plurality of RIS beams.

8. The method of claim 1, further comprising transmitting information on the number of the RIS beams required to perform sweeping on an entire RIS area, to the base station when the RIS makes initial access to the base station.

9. A base station (BS) in a wireless communication system, the base station comprising:
a transceiver; and
a controller operably connected to the transceiver,
wherein the controller is configured to
perform a beam search using at least one base station beam through a backhaul link between the base station and a reconfigurable intelligent surface (RIS),
perform the beam search using a plurality of RIS beams for each of the at least one base station beam on the backhaul link when the RIS is set to a multi-beam mode,
set the RIS to a single-beam mode on an access link when the beam search of the backhaul link is completed, and
perform a beam search of the access link by fixing beam information of the backhaul link.

10. The base station of claim 9, wherein when a frequency band used on a control link of the RIS is the same as a frequency band of the backhaul link or is included in the frequency band of the backhaul link, a beam used on the control link is used in the same manner on the backhaul link.

11. The base station of claim 9, wherein when a frequency band used on a control link of the RIS is different from a frequency band of the backhaul link or is not included in the backhaul link, the beam search of the backhaul link is performed in cooperation with a user equipment (UE).

12. The base station of claim 10, wherein when beam failure detection (BFD) occurs at a user equipment, but BFD does not occur at an RIS controller included in the RIS, an existing beam is still used on the backhaul link and beam failure recovery (BFR) is not performed.

13. The base station of claim 10, wherein when beam failure detection (BFD) occurs at a user equipment and BFD occurs at an RIS controller included in the RIS, beam failure recovery (BFR) is performed for the control link, and
beam information of the control link is applied to the backhaul link.

14. The base station of claim 9, wherein when the base station performs the beam search for the access link, a beam of the backhaul link is fixed and the RIS is set to the single-beam mode.

15. The base station of claim 14, wherein when the beam search for the access link is performed, the plurality of RIS beams are set on the basis of the beam information of the backhaul link, and
the beam search of the access link is performed while changing an ID of each of the plurality of RIS beams.

16. The base station of claim 9, wherein the controller is further configured to transmit information on the number of the RIS beams required to perform sweeping on an entire RIS area, to the base station when the RIS makes initial access to the base station.
